(19) United States
(12) Patent Application Publication
(10) Pub. No.: US 2025/0247480 A1
(43) Pub. Date: Jul. 31, 2025

(54) IMAGE PROCESSING APPARATUS FOR SORTING IMAGE DATA INTO STORAGE LOCATION, METHOD FOR CONTROLLING IMAGE PROCESSING APPARATUS, AND STORAGE MEDIUM

(71) Applicant: CANON KABUSHIKI KAISHA, Tokyo (JP)

(72) Inventor: TAKUYA USHINOHAMA, Ibaraki (JP)

(21) Appl. No.: 19/025,784

(22) Filed: Jan. 16, 2025

(30) Foreign Application Priority Data
Jan. 25, 2024 (JP) 2024-009370

(51) Int. Cl. H04N 1/00; G06V 10/94; G06V 30/196; G06V 30/413

(52) U.S. Cl. CPC H04N 1/00824; G06V 10/95; G06V 30/1983; G06V 30/413; H04N 1/00244; H04N 1/00395; H04N 2201/0094

(57) ABSTRACT

An image processing apparatus that can sort image data into storage locations using a generative AI service. An image of a document and generate image data is read, a prompt for causing generative AI to execute image analysis for extracting a predetermined character string from the image data is received, the image data and the prompt are transmitted to the generative AI, the character string extracted through the image analysis performed by the generative AI is acquired, and control to store the image data in a folder indicated by a folder path including the character string that has been acquired is performed.

### BACKGROUND OF THE INVENTION

### Field of the Invention

The present invention relates to an image processing apparatus, a method for controlling an image processing apparatus, and a storage medium.

### Description of the Related Art

An image processing apparatus that reads an image of a document and generates image data is known. A technique disclosed in Japanese Laid-Open Patent Publication (kokai) No. 2020-86717 is proposed as a technique for storing such image data. In Japanese Laid-Open Patent Publication (kokai) No. 2020-86717, generated image data is stored in a folder having a name with a character obtained by performing character recognition processing on the generated image data. This can sort the image data into an appropriate storage location for each character included in the generated image data.

On the other hand, a generative AI service that executes image analysis processing using generative AI is used. In the generative AI service, a user needs to enter a free-selected prompt.

However, in the technique of Japanese Laid-Open Patent Publication (kokai) No. 2020-86717 described above, since the character recognition processing is executed by an image processing apparatus, it is not assumed that the character recognition processing is performed using a generative AI service.

### SUMMARY OF THE INVENTION

The present invention provides an image processing apparatus that can sort image data into storage locations using a generative AI service, a method for controlling the image processing apparatus, and a storage medium.

According to an aspect of the invention, the present invention provides an image processing apparatus comprising a reading part configured to read an image of a document and generate image data, an operation part configured to receive a prompt for causing generative AI to execute image analysis for extracting a predetermined character string from the image data, and at least one memory and at least one processor which function as a transmission unit configured to transmit the image data and the prompt to the generative AI, an acquisition unit configured to acquire the character string extracted through the image analysis performed by the generative AI, and a control unit configured to perform control to store the image data in a folder indicated by a folder path including the character string that has been acquired.

According to the present invention, image data can be sorted into storage locations using a generative AI service.

Further features of the present invention will become apparent from the following description of exemplary embodiments (with reference to the attached drawings).

### BRIEF DESCRIPTION OF THE DRAWINGS

FIG. 1 is a block diagram showing a configuration example of a system including an MFP as an image processing apparatus according to the present embodiment.

FIG. 2 is a block diagram schematically showing a hardware configuration of the MFP in FIG. 1.

FIG. 3 is a block diagram schematically showing a hardware configuration of a user terminal in FIG. 1.

FIG. 4 is a block diagram schematically showing a hardware configuration of a generative AI server in FIG. 1.

FIG. 5 is a block diagram schematically showing a hardware configuration of a storage server in FIG. 1.

FIG. 6 is a sequence diagram showing a procedure of processing for storing scanned image data generated by scanning a document with the MFP in FIG. 1 into a storage location determined based on an analysis result of image analysis performed by a generative AI server.

FIG. 7 is a screen transition diagram of an operation part in FIG. 2.

FIG. 8 is a flowchart showing a procedure of scan control processing executed by the MFP in FIG. 1.

FIG. 9 is a diagram showing an example of a job execution button setting screen for registering a job execution button displayed on a home screen in FIG. 7.

### DESCRIPTION OF THE EMBODIMENTS

Hereinafter, an embodiment of the present invention will be described in detail with reference to the drawings. In the present embodiment, a multi function peripheral (MFP) having a plurality of functions such as a printing function, a scanning function, and a facsimile function will be described as an example of an image processing apparatus.

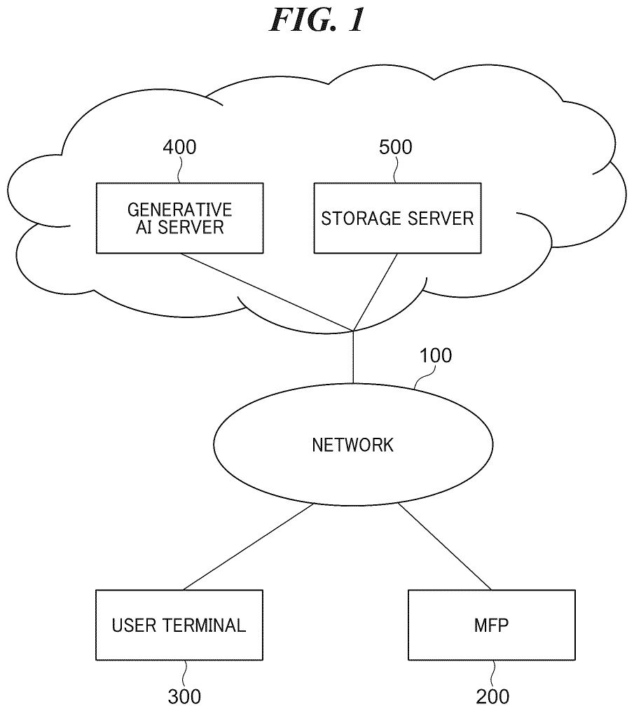

FIG. 1 is a block diagram showing a configuration example of a system including an MFP 200 as an image processing apparatus according to the present embodiment. In this system, as illustrated in FIG. 1, the MFP 200 and a user terminal 300 are communicably connected to a generative AI server 400 and a storage server 500 via a network 100. It should be noted that the network 100 may be the Internet or a local area network (LAN). The network 100 may be either wired or wireless.

The MFP 200 has a function of scanning and digitizing a paper document. The MFP 200 transmits scanned image data generated by scanning the paper document to the storage server 500. The user terminal 300 is, for example, an electronic device such as a personal computer, a smartphone, or a tablet PC owned by the user. The user terminal 300 communicates with the MFP 200 via the network 100, and can perform function setting of the MFP 200 from a browser or the like operating on the user terminal 300.

The generative AI server 400 communicates with the MFP 200 via the network 100 and receives scanned image data generated by the MFP 200 and a prompt serving as an instruction to execute image analysis for extracting a predetermined character string from the scanned image data. The generative AI server 400 interprets the received prompt and returns an answer (response) to the prompt to the MFP 200.

The storage server 500 is a network attached storage (NAS) or the like. The storage server 500 is a server that manages files according to a file sharing protocol such as Common Internet File System (CIFS) or Network File System (NFS).

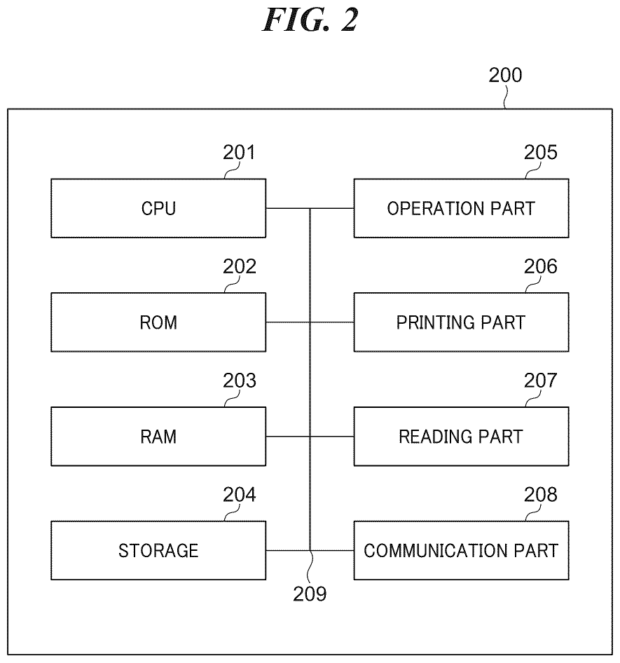

FIG. 2 is a block diagram schematically showing a hardware configuration of the MFP 200 in FIG. 1. In FIG. 2, the MFP 200 includes a CPU 201, a ROM 202, a RAM 203, a storage 204, an operation part 205, a printing part 206, a reading part 207, and a communication part 208. These are connected to each other via a bus 209.

The CPU 201 controls the entire operation of the MFP 200. The CPU 201 reads a control program stored in the ROM 202 or the storage 204 to the RAM 203, and executes the control program read to the RAM 203 to perform various controls such as reading control and printing control. The ROM 202 stores a control program that can be executed by the CPU 201. The RAM 203 is a main storage memory, and is used as a temporary storage area for developing various control programs stored in a work area, the ROM 202, and the storage 204. The storage 204 stores image data, print data, various programs, and various types of setting information. It should be noted that, in the present embodiment, a flash memory is assumed as the storage 204, but a storage device such as a solid state drive (SSD) or a hard disc drive (HDD) may be used. In addition, an embedded Multi Media Card (eMMC) may be used as the storage 204. It should be noted that, in the MFP 200 according to the present embodiment, one CPU 201 uses one RAM 203 to execute each type of processing shown in a sequence described later, but the present invention is not limited to this configuration. For example, a plurality of CPUs, RAMs, ROMs, and storages can be caused to cooperate with each other to execute each type of processing shown in the sequence described later. In addition, some type of processing may be executed using a hardware circuit such as ASIC or FPGA.

The operation part 205 is, for example, a display part such as a touch panel or a hard key. The operation part 205 displays information to the user and detects an input from the user. For example, the operation part 205 receives a prompt input from the user. The printing part 206 prints the image data (print data) stored in the RAM 203 on the recording paper fed from a paper feeding cassette. The reading part 207 reads an image of a document, and the CPU 201 converts the image into scanned image data such as binary data. The scanned image data generated based on the image read by the reading part 207 is transmitted to an external device or printed on recording paper by the printing part 206.

The communication part 208 is connected to the network 100. The communication part 208 transmits image data to an external device on the network 100 and receives print data from the user terminal 300. For example, the communication part 208 transmits image data and a prompt to the generative AI server 400. As a method of transmission and reception via the network 100, transmission and reception using electronic mails and file transmission using other protocols (for example, FTP, SMB, WEBDAV, and the like) can be performed. Further, various types of setting data can be transmitted and received via the network 100 through access by HTTP communication from the user terminal 300.

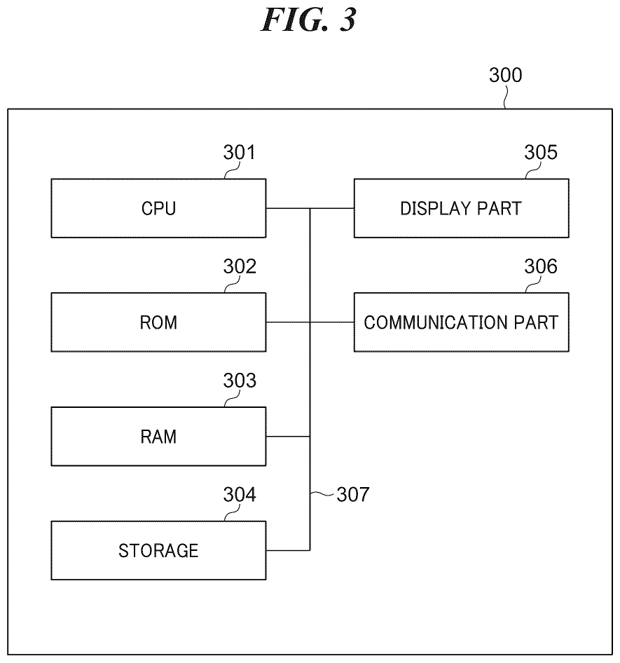

FIG. 3 is a block diagram schematically showing a hardware configuration of the user terminal 300 in FIG. 1. In FIG. 3, the user terminal 300 includes a CPU 301, a ROM 302, a RAM 303, a storage 304, a display part 305, and a communication part 306. These are connected to each other via a bus 307.

The CPU 301 controls the entire operation of the user terminal 300. The CPU 301 reads a control program stored in the ROM 302 or the storage 304 into the RAM 303, and executes the control program read into the RAM 303 to execute various type of processing for controlling the operation of the user terminal 300. The ROM 302 stores a control program that can be executed by the CPU 301. The RAM 303 is a main storage memory, and is used as a temporary storage area for developing various control programs stored in a work area, the ROM 302, and the storage 304. The storage 304 stores application data, various programs, and various types of setting information. The display part 305 is a display device such as a liquid crystal panel, which displays image data processed by the CPU 301, for example. The communication part 306 transmits and receives data to and from the generative AI server 400, the storage server 500, and the MFP 200 via the network 100.

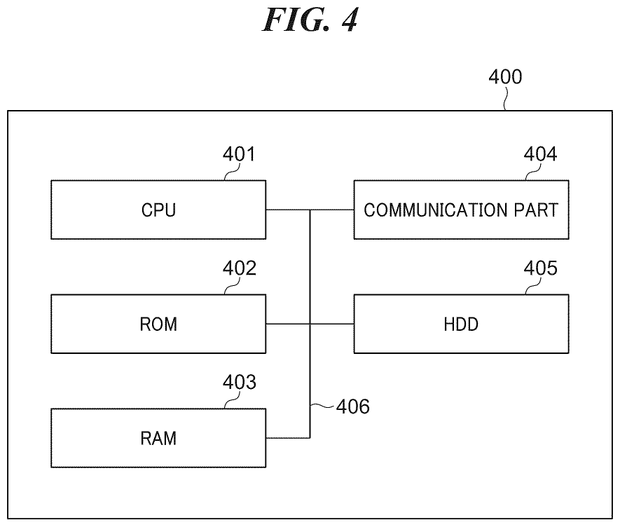

FIG. 4 is a block diagram schematically showing a hardware configuration of the generative AI server 400 in FIG. 1. In FIG. 4, the generative AI server 400 includes a CPU 401, a ROM 402, a RAM 403, a communication part 404, and an HDD 405. These are connected to each other via a bus 406.

The CPU 401 executes processing for controlling the operation of generating an appropriate response using the control program stored in the ROM 402 or a learning model as the generative AI stored in the HDD 405. The learning model includes an image analysis function, and generates a text or an image in response to an input prompt. For example, when a natural language question such as “What is shown in the image?” is input as a prompt, the learning model performs image analysis corresponding to the question and generates an answer to the question. This answer includes, for example, the name of the object shown in the image.

The ROM 402 stores a control program. The RAM 403 is used as a temporary storage area such as a main memory or a work area of the CPU 401. The HDD 405 stores various types of data such as a learning model or a generative AI application. The communication part 404 exchanges data with various devices such as the user terminal 300 and the MFP 200. It should be noted that the communication part 404 may perform wired communication using Ethernet (registered trademark) or may perform wireless communication such as Wi-Fi.

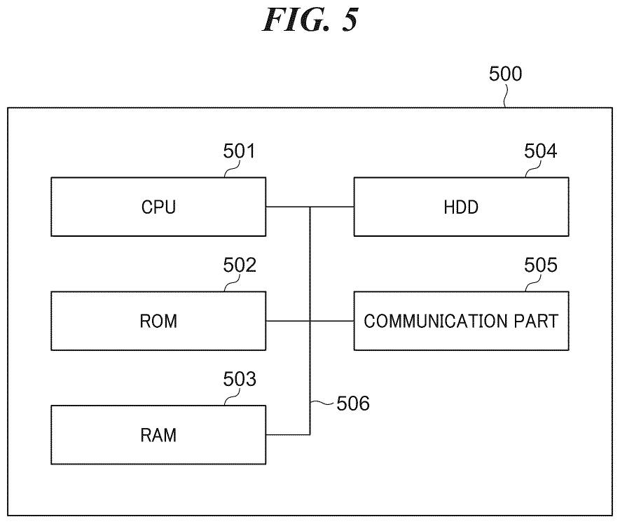

FIG. 5 is a block diagram schematically showing a hardware configuration of the storage server 500 in FIG. 1. In FIG. 5, the storage server 500 includes a CPU 501, a ROM 502, a RAM 503, an HDD 504, and a communication part 505. These are connected to each other via a bus 506.

The CPU 501 reads a control program stored in the ROM 502 into the RAM 503, and executes the control program read into the RAM 503 to execute various type of processing for controlling the operation of the storage server 500. The ROM 502 stores a control program. The RAM 503 is used as a temporary storage area such as a main memory or a work area of the CPU 501. The HDD 504 stores a file. The communication part 505 receives a file from the MFP 200 or the user terminal 300 via the Internet 100 and stores the received file in the HDD 504. The communication part 505 also transmits the file stored in the HDD 504 to the MFP 200 or the user terminal 300. It should be noted that the communication part 505 may perform wired communication using Ethernet or may perform wireless communication such as Wi-Fi.

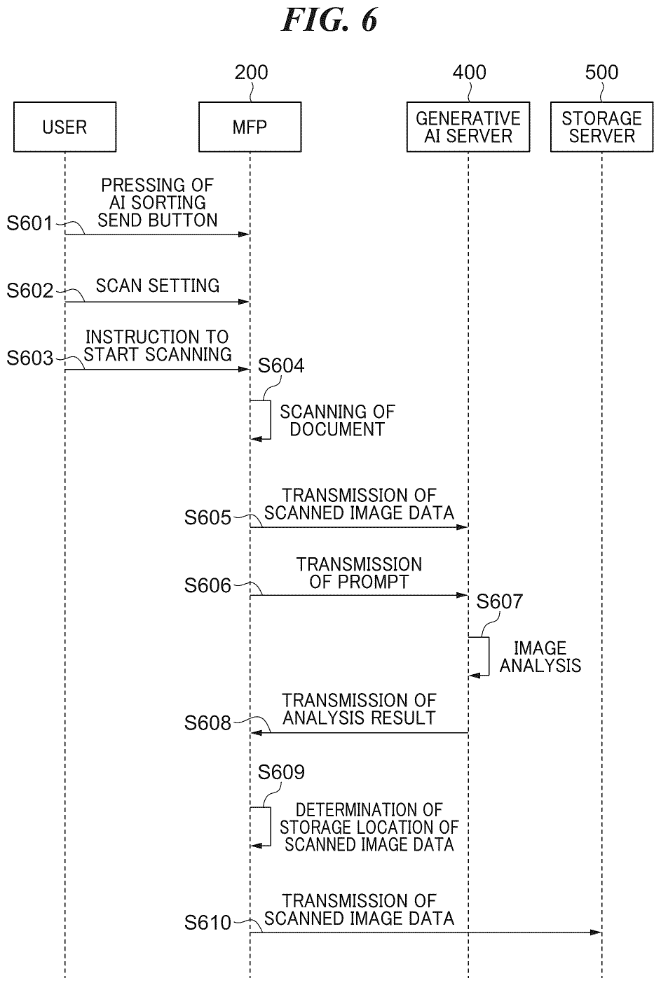

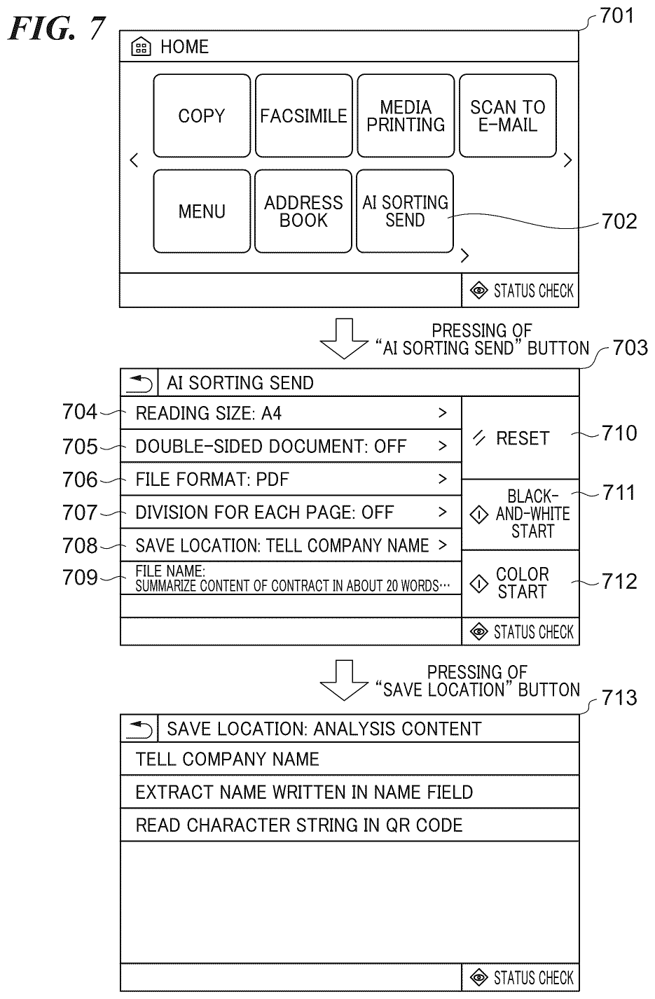

FIG. 6 is a sequence diagram showing a procedure of processing for storing scanned image data generated by scanning a document with the MFP 200 in FIG. 1 into a storage location determined based on an analysis result of image analysis performed by the generative AI server 400. It should be noted that a home screen 701 in FIG. 7 is assumed to be displayed on the operation part 205 of the MFP 200. The home screen 701 includes buttons corresponding to the functions of the MFP 200, such as a copy button and a facsimile button, and a job execution button such as an “AI SORTING SEND” button 702.

In FIG. 6, first, when the user presses the “AI SORTING SEND” button 702 on the home screen 701 (S601), the screen of the operation part 205 of the MFP 200 is switched from the home screen 701 to an AI sorting SEND setting screen 703.

Next, the user performs scan setting on the AI sorting SEND setting screen 703 (S602). Specifically, the user sets, as scan settings, a reading size 704, a double-sided document 705, a file format 706, a division for each page 707, a save location 708, and a file name 709. The reading size 704 is a setting related to the size of the document to be scanned. The double-sided document 705 is a setting as to whether to read both sides of the document to be scanned. The file format 706 is a setting related to a file format of scanned image data to be generated through scanning. In the division for each page 707, either ON or OFF is set. When OFF is set in the division for each page 707, one piece of scanned image data including data of all pages is generated when a document of a plurality of pages is scanned. On the other hand, when ON is set in the division for each page 707, a plurality of pieces of scanned image in which a plurality of pages are divided for each designated number of pages when a document of a plurality of pages is scanned. The save location 708 is a setting related to a storage location of scanned image data to be generated through scanning. The file name 709 is a setting related to a file name of scanned image data to be generated through scanning. It should be noted that, when the user selects a reset button 710, the information set on the AI sorting SEND setting screen 703 is cleared.

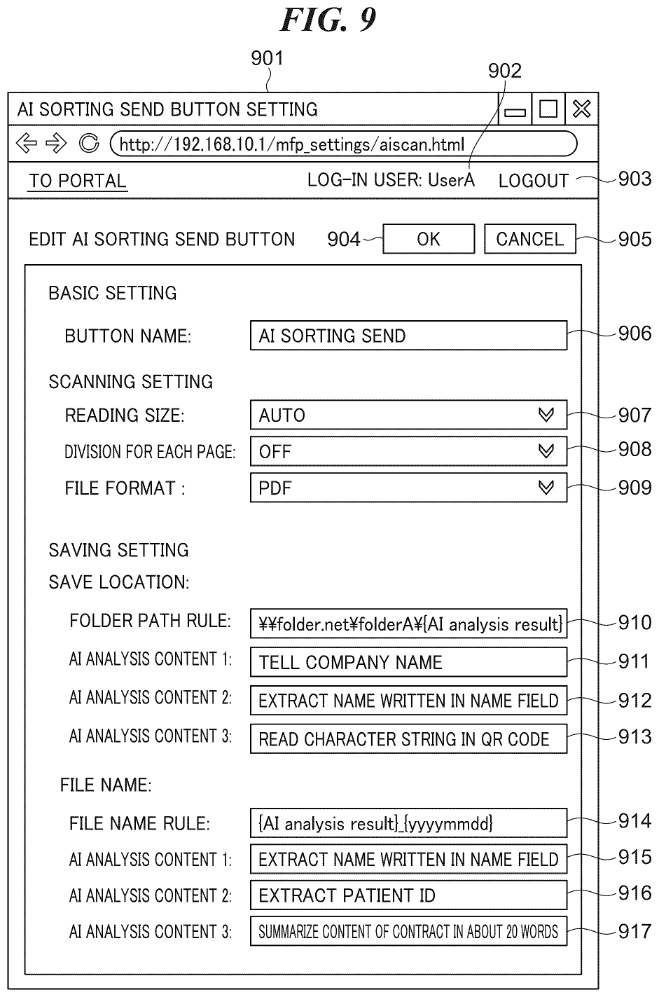

For example, when the user selects the save location 708, the screen of the operation part 205 of the MFP 200 is switched from the AI sorting SEND setting screen 703 to a save location prompt selection screen 713. On the save location prompt selection screen 713, a list of prompts registered on a job execution button setting screen 901 in FIG. 9 to be described later is displayed. This prompt is a prompt for causing the generative AI server 400 to execute image analysis for extracting a predetermined character string to be used for determining the storage location from the scanned image data generated through scanning. In FIG. 7, as an example, prompts such as “TELL COMPANY NAME”, “TELL NAME WRITTEN IN NAME FIELD”, and “READ CHARACTER STRING OF QR CODE” are displayed. When the user selects a prompt from the list displayed on the save location prompt selection screen 713, the screen of the operation part 205 of the MFP 200 is switched from the save location prompt selection screen 713 to the AI sorting SEND setting screen 703. In the save location 708 of the AI sorting SEND setting screen 703, the prompt selected by the user on the save location prompt selection screen 713 is set. In this manner, a prompt for causing the generative AI server 400 to execute image analysis for extracting a predetermined character string to be used for determining the storage location is set in the save location 708 instead of a folder path itself indicating the storage location of the scanned image data.

In addition, when the user selects the file name 709, the screen of the operation part 205 of the MFP 200 is switched from the AI sorting SEND setting screen 703 to a file name prompt selection screen (not shown). On the file name prompt selection screen, a list of prompts registered on the job execution button setting screen 901 in FIG. 9 to be described later is displayed. This prompt is a prompt for causing the generative AI server 400 to execute image analysis for extracting a predetermined character string to be used for determining the file name from the scanned image data generated through scanning. When the user selects a prompt from the list displayed on the file name prompt selection screen, the screen of the operation part 205 of the MFP 200 is switched from the file name prompt selection screen to the AI sorting SEND setting screen 703. In the file name 709 of the AI sorting SEND setting screen 703, the prompt selected by the user on the file name prompt selection screen is set. In this manner, a prompt for causing the generative AI server 400 to execute image analysis for extracting a predetermined character string to be used for determining the file name is set in the file name 709 instead of a file name itself of the scanned image data.

Next, the user issues an instruction to start document scanning (S603). In the present embodiment, the user can issue the instruction to start document scanning by selecting a black-and-white start button 711 or a color start button 712 on the AI sorting SEND setting screen 703.

The CPU 201 of the MFP 200 that has received the instruction to start document scanning controls the reading part 207 to scan the set document (S604). In S604, the document is scanned based on the setting information of the reading size 704, the double-sided document 705, the file format 706, and the division for each page 707 of the AI sorting SEND setting screen 703. Through this scanning, scanned image data is generated.

Next, the CPU 201 of the MFP 200 controls the communication part 208 to transmit the scanned image data generated in S604 to the generative AI server 400 (S605). The CPU 201 also controls the communication part 208 to transmit the prompt set on the AI sorting SEND setting screen 703 to the generative AI server 400 (S606).

The CPU 401 of the generative AI server 400 that has received the scanned image data and the prompt performs image analysis of extracting a predetermined character string corresponding to the prompt from the scanned image data using the learning model stored in the HDD 405 (S607). For example, when the received prompt is “TELL COMPANY NAME”, in the image analysis using the learning model, a predetermined character string indicating the company name is extracted from the scanned image data.

The CPU 401 of the generative AI server 400 controls the communication part 404 to transmit a predetermined character string extracted from the scanned image data to the MFP 200 as an analysis result (S608).

Next, the CPU 201 of the MFP 200 determines a storage location of the scanned image data by using the analysis result received from the generative AI server 400 as a part of a folder path (S609).

Next, the CPU 201 of the MFP 200 controls the communication part 208 to transmit the scanned image data generated in S604 to the storage server 500 (S610). At this time, the storage location determined in S609 is designated as the storage location of the scanned image data. As a result, in the storage server 500, the scanned image data generated in S604 is stored in the storage location determined in S609. Thereafter, the present processing ends.

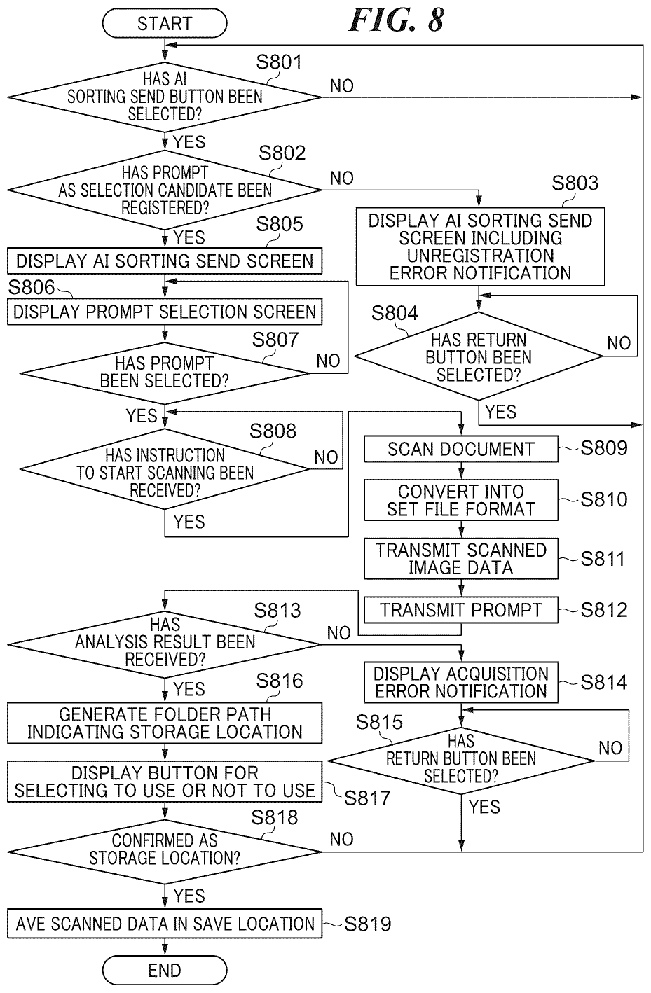

FIG. 8 is a flowchart showing a procedure of scan control processing executed by the MFP 200 in FIG. 1. The scan control processing is implemented by the CPU 201 of the MFP 200 reading a program stored in the ROM 202 into the RAM 203 and executing the program read into the RAM 203. The scan control processing starts when the power of the MFP 200 is turned on and the home screen 701 is displayed on the operation part 205.

In FIG. 8, first, the CPU 201 determines whether the “AI SORTING SEND” button 702 has been selected (S801). When it is determined in S801 that the “AI SORTING SEND” button 702 is not selected, the present processing returns to S801. When it is determined in S801 that the “AI SORTING SEND” button 702 has been selected, the present processing proceeds to S802.

In S802, the CPU 201 determines whether a prompt as a selection candidate has been registered in the save location 708 and the file name 709. When it is determined in S802 that no prompt as a selection candidate has been registered in the save location 708 or the file name 709, the present processing proceeds to S803.

In S803, the CPU 201 causes the operation part 205 to display the AI sorting SEND setting screen 703 including an unregistration error notification indicating that no prompt as a selection candidate has been registered in the save location 708 or the file name 709. Next, the CPU 201 determines whether the “RETURN” button on the AI sorting SEND setting screen 703 has been selected (S804). When it is determined in S804 that the “RETURN” button is not selected, the present processing returns to S804. On the other hand, when it is determined in S804 that the “RETURN” button has been selected, the present processing returns to S801.

When it is determined in S802 that a prompt as a selection candidate has been registered in the save location 708 and the file name 709, the present processing proceeds to S805.

In S805, the CPU 201 causes the operation part 205 to display the AI sorting SEND setting screen 703. When the save location 708 or the file name 709 of the AI sorting SEND setting screen 703 is selected, the CPU 201 causes the operation part 205 to display the prompt selection screen corresponding to the selected item (S806). In the following description, as an example, it is assumed that the save location 708 is selected by the user, and the save location prompt selection screen 713 is displayed on the operation part 205.

Next, the CPU 201 determines whether a prompt has been selected on the save location prompt selection screen 713 displayed on the operation part 205 (S807). When it is determined in S807 that no prompt has been selected on the save location prompt selection screen 713, the present processing returns to S806. On the other hand, when it is determined in S807 that a prompt has been selected on the save location prompt selection screen 713, the present processing proceeds to S808.

In S808, the CPU 201 determines whether an instruction to start document scanning has been received. In S808, when neither the black-and-white start button 711 nor the color start button 712 is selected by the user on the AI sorting SEND setting screen 703, it is determined that the instruction to start document scanning has not been received, and the present processing returns to S808. On the other hand, when the black-and-white start button 711 or the color start button 712 is selected by the user on the AI sorting SEND setting screen 703, it is determined that an instruction to start document scanning has been received, and the present processing proceeds to S809. It should be noted that, in the present embodiment, when it is determined that an instruction to start document scanning has been received and no prompt is set in at least one of the save location 708 and the file name 709, the present processing may return to S806. In S806, a prompt selection screen corresponding to an item for which no prompt is set is displayed on the operation part 205.

In S809, the CPU 201 controls the reading part 207 based on the information set on the AI sorting SEND setting screen 703 and scans the set documents. Scanned image data is thus generated. It should be noted that, when a document of a plurality of pages are scanned, one piece of scanned image data including data of all pages or a plurality of pieces of scanned image data divided for each designated number of pages is generated according to the setting of the division for each page 707 on the AI sorting SEND setting screen 703.

Next, the CPU 201 converts the scanned image data generated in S809 into the file format set to the file format 706 of the AI sorting SEND setting screen 703 (S810).

Next, the CPU 201 controls the communication part 208 to transmit the scanned image data whose file format has been converted in S810 to the generative AI server 400 (S811). The CPU 201 also controls the communication part 208 to transmit the prompt selected in S807 to the generative AI server 400 (S812). It should be noted that when a plurality of pieces of scanned image data are generated in S810, the processing of S811 and S812 is performed on each of the pieces of scanned image data.

Next, the CPU 201 determines whether an analysis result has been received from the generative AI server 400 (S813). In S813, when the status code in the response of the HTTP communication is an error or when the body information of the response includes a parameter indicating that information cannot be acquired, it is determined that the analysis result is not received from the generative AI server 400. In this case, the present processing proceeds to S814.

In S814, the CPU 201 displays an acquisition error notification indicating that the analysis result could not be received on the AI sorting SEND setting screen 703. Next, the CPU 201 determines whether the “RETURN” button on the AI sorting SEND setting screen 703 has been selected (S815). When it is determined in S815 that the “RETURN” button of the AI sorting SEND setting screen 703 is not selected, the present processing returns to S815. On the other hand, when it is determined in S815 that the “RETURN” button of the AI sorting SEND setting screen 703 has been selected, the present processing returns to S801.

When it is determined in S813 that the analysis result has been received from the generative AI server 400, the CPU 201 generates a folder path indicating the storage location of the scanned image data based on the received analysis result (S816). In step S816, a folder path is generated according to a folder path rule preset as a job setting in a folder path rule setting field 910 of the job execution button setting screen 901 in FIG. 9 described later. It should be noted that in S816, the folder path may be generated according to another folder path generation rule. For example, by setting a folder path rule using a keyword (“{AI analysis result}” in the present embodiment) that replaces the character string obtained as the analysis result, the data is sorted into a storage location according to the analysis result. For example, when the folder path rule is “¥¥folder.net¥folderA¥ {AI analysis result}”, and “0123” is received as the analysis result from the generative AI server 400, a folder path such as “¥¥folder.net¥folderA¥0123” is generated in S816. It should be noted, as a keyword, “{yyyymmdd}” that is replaced with the year, month, and date when the scan is executed may be prepared in advance.

Next, the CPU 201 displays the folder path generated in S814 on the AI

sorting SEND setting screen 703. The CPU 201 also displays a button for selecting whether to use (confirm) or not use (cancel) the folder indicated by the folder path as the storage location on the AI sorting SEND setting screen 703 (S817). It should be noted that, a keyboard may be displayed on the operation part 205 so that the user can edit the folder path generated in S814.

Next, the CPU 201 determines whether the folder indicated by the folder path has been confirmed as the storage location (S818). When it is determined in S818 that the folder indicated by the folder path has been cancelled as the storage location, the present processing returns to S801. On the other hand, when it is determined in S818 that the folder indicated by the folder path has been confirmed as the storage location, the present processing proceeds to S819.

In S819, the CPU 201 transmits the scanned image data whose file format has been converted in S810 to the storage server 500. At this time, the folder path conformed in S818 is designated as the storage location of the scanned image data. As a result, in the storage server 500, the scanned image data transmitted from the MFP 200 is saved in the folder indicated by the folder path confirmed in S818. Thereafter, the present processing ends.

FIG. 9 is a diagram showing an example of the job execution button setting screen 901 for registering a job execution button displayed on the home screen 701 in FIG. 7. The job execution button setting screen 901 is displayed when the user accesses a button setting page provided by an HTTP server (not shown) of the MFP 200 from a browser of a PC operated by the user. In FIG. 9, as an example, information related to the “AI SORTING SEND” button 702 is set. It should be noted that, in the present embodiment, a configuration in which the job execution button setting screen 901 is displayed on the display part of the PC operated by the user will be described, but the present invention is not limited to this configuration. For example, a screen corresponding to the job execution button setting screen 901 may be displayed on the operation part 205 of the MFP 200.

In a log-in user field 902, the name of the user who has logged in to the MFP 200 to set the job execution button from the browser is displayed. When the setting of “AI SORTING SEND” button 702 is performed, a user having administrator authority of the MFP 200 or a general user having such settable authority logs in to the MFP 200. When a logout button 903 is selected, the user logs out of the MFP 200, and a screen indicating that the user has logged out of the MFP 200 is displayed on the browser.

When the user selects an OK button 904, the MFP 200 stores the job setting set in fields 906 to 917 into the storage 204, and displays a job execution button for executing a job according to the job setting on the home screen 701. When the user selects a cancel button 905, the MFP 200 clears the information set in fields 906 to 917 and ends the button setting.

In a button name field 906, the name of the job execution button displayed on the home screen 701 is set. The values set in a reading size selection field 907, a division selection field for each page 908, and a file format selection field 909 are used as initial values of the reading size 704, the file format 706, and the division for each page 707 on the AI sorting SEND setting screen 703, respectively.

A folder path generation rule indicating the storage location of the scanned image data is set in the folder path rule setting field 910. In AI analysis content setting fields 911 to 913, a prompt for causing the generative AI server 400 to execute image analysis for extracting a character string to be used for the folder path from the scanned image data is set. The prompt set in the AI analysis content setting fields 911 to 913 is displayed as an option on the save location prompt selection screen 713. It should be noted that FIG. 9 illustrates, as an example, a configuration in which three prompts can be registered, but the number of prompts that can be registered is not limited to three.

A file name generation rule of the scanned image data is set in a file name rule setting field 914. In AI analysis content setting fields 915 to 917, a prompt for causing the generative AI server 400 to execute image analysis for extracting a character string to be used for the file name of the scanned image data from the scanned image data is set. The prompt set in the AI analysis content setting fields 915 to 917 is displayed as an option on the file name prompt selection screen displayed on the operation part 205 when the file name 709 is selected.

According to the above-described embodiment, scanned image data is generated through reading of an image of a document, and a prompt for causing the generative AI server 400 to execute image analysis for extracting a predetermined character string from the scanned image data is received. The scanned image data and the prompt are transmitted to the generative AI server 400, an analysis result of the image analysis performed by the generative AI server 400 is acquired, and control is performed to store the scanned image data in a folder indicated by a folder path including a character string of the acquired analysis result. This can sort the image data into a storage location using a generative AI service.

In the above-described embodiment, a prompt to be transmitted to the

generative AI server 400 is registered in association with the “AI SORTING SEND” button 702 which is a job execution button. This allows the user to instruct the generative AI server 400 to execute the image analysis only by pressing the “AI SORTING SEND” button 702 without inputting a prompt.

In the above-described embodiment, the folder path is displayed on the operation part 205, and the user is caused to select whether to store the scanned image data in the folder indicated by the folder path. This can prevent the scanned image data from being stored in an unintended folder.

In the above-described embodiment, a keyboard for allowing the user to edit the folder path is displayed on the operation part 205. This allows the user to change the storage location of the scanned image data with less trouble based on the folder path generated according to the analysis result of the image analysis performed by the generative AI server 400.

It should be noted that, in the above-described embodiment, the configuration in which the scanned image data is directly transmitted to the generative AI server 400 in S811 has been described, but the present invention is not limited to be applied to this configuration. For example, after the scanned image data is stored in the storage server 500, a file path designating the scanned image data may be notified to the generative AI server 400 in S811.

In the above-described embodiment, as an example, the configuration of determining the storage location of the scanned image data using the analysis result generated by the generative AI server 400 has been described. However, the analysis result generated by the generative AI server 400 may be used for determining the file name of the scanned image data.

In the present embodiment, when it is determined in S818 that the folder path displayed on the AI sorting SEND setting screen 703 has been canceled as the storage location, a screen for editing a prompt may be displayed on the operation part 205. On this screen, the prompt transmitted to the generative AI server 400 in S812 can be edited. For example, when the prompt transmitted to the generative AI server 400 in S812 is “TELL COMPANY NAME”, the user edits the prompt to “TELL COMPANY NAME ENDING WITH CO. LTD.”. That is, a prompt such as “ENDING WITH CO. LTD.” is added to a prompt such as “TELL COMPANY NAME”. Thereafter, the present processing returns to S811, and in S812, the prompt edited by the user is transmitted to the generative AI server 400. With this control, when the result that the user wanted cannot be obtained in the image analysis performed by the generative AI server 400, it is possible to change execution conditions of the image analysis and cause the generative AI server 400 to execute the image analysis again. As a result, the scanned image data can be controlled to be stored in an intended storage location.

In the present embodiment, a configuration has been described in which the generative AI server 400 is caused to execute image analysis for extracting a predetermined character string from scanned image data. However, the present invention is not limited to be applied to this configuration, and the MFP 200 may include generative AI. For example, in S605 and S811, the CPU 201 of the MFP 200 inputs the scanned image data to a learning model as the generated AI stored in the storage 204 or the like. In addition, in S606 and S812, the CPU 201 inputs a prompt to the learning model. This learning model performs the image analysis using these data as inputs. Such a configuration can also obtain the same effects as those of the above-described embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-009370, filed Jan. 25, 2024 which is hereby incorporated by reference wherein in its entirety.

What is claimed is:

1. An image processing apparatus comprising:
a reading part configured to read an image of a document and generate image data;
an operation part configured to receive a prompt for causing generative AI to execute image analysis for extracting a predetermined character string from the image data; and
at least one memory and at least one processor which function as:
a transmission unit configured to transmit the image data and the prompt to the generative AI;
an acquisition unit configured to acquire the character string extracted through the image analysis performed by the generative AI; and
a control unit configured to perform control to store the image data in a folder indicated by a folder path including the character string that has been acquired.

2. The image processing apparatus according to claim 1, wherein
a job execution button for executing a job of reading an image of a document, generating image data, and storing the image data in the folder indicated by the folder path is registered, and
the prompt is registered in association with the job execution button.

3. The image processing apparatus according to claim 1, wherein the at least one memory and the at least one processor further function as:
a display unit configured to display the folder path, and
a selection unit configured to allow a user to select whether to store the image data in the folder indicated by the folder path.

4. The image processing apparatus according to claim 3, wherein the at least one memory and the at least one processor further function as
an editing unit configured to cause a user to edit the folder path.

5. The image processing apparatus according to claim 3, wherein
when the user selects not to store the image data in the folder indicated by the folder path, the transmission unit transmits the image data and another prompt in which supplementary information is added to the prompt to the generative AI.

6. A method for controlling an image processing apparatus, the method comprising the steps of:
reading an image of a document and generating image data;
receiving a prompt for causing generative AI to execute image analysis for extracting a predetermined character string from the image data;
transmitting the image data and the prompt to the generative AI;
acquiring the character string extracted through the image analysis performed by the generative AI; and
performing control to store the image data in a folder indicated by a folder path including the character string that has been acquired.

7. A computer-readable non-transitory storage medium storing a program to cause a computer to execute a method for controlling an image processing apparatus, the method comprising the steps of:
reading an image of a document and generating image data;
receiving a prompt for causing generative AI to execute image analysis for extracting a predetermined character string from the image data;
transmitting the image data and the prompt to the generative AI;
acquiring the character string extracted through the image analysis performed by the generative AI; and
performing control to store the image data in a folder indicated by a folder path including the character string that has been acquired.
